(19) United States
(12) Patent Application Publication
(10) Pub. No.: US 2012/0314852 A1
(43) Pub. Date: Dec. 13, 2012

(54) Pairing and Sharing Between a Non-Mobile Telephone System and a Computer System Call Features in a Non-Mobile Telephone System

(75) Inventors: Ravin Suri, Oakton, VA (US); Scott M. Ober, Oakton, VA (US); Stephen J. Schmitt, Mears, MI (US)

(73) Assignee: CLOUD TC, INC., PALO ALTO, CA (US)

(21) Appl. No.: 13/198,690

(22) Filed: Aug. 4, 2011

Related U.S. Application Data
(60) Provisional application No. 61/370,803, filed on Aug. 4, 2010.
(60) Provisional application No. 61/371,157, filed on Aug. 5, 2010.

(51) Int. Cl. H04M 15/00

(52) U.S. Cl. 379/114.01

(57) ABSTRACT

Technology for a non-mobile telephone system which in addition to processing voice signal data, can execute applications transferring data responsive to user input received through a graphical user interface of the telephone system. Examples of call features include a call back feature and a service ordering feature. The graphical user interface provides visual displays to assist a user in selecting call features. Non-voice signal data retrieved from another computer system can be transferred with a call from the non-mobile telephone system. The non-mobile telephone system can pair with the other computer system for security. An example of a sharing data is downloading a file stored on the other computer system or sharing the screen of the other computer system at a resource location accessible by a caller on the other end of a call with the non-mobile telephone system.

### RELATED APPLICATIONS

The present application claims the benefit of priority under 35 U.S.C. 119(e) to U.S. Provisional Application Ser. No. 61/370,803, entitled “Pairing and Sharing Between a Non-Mobile Telephone System and a Computer System,” filed Aug. 4, 2010, and U.S. Provisional Application Ser. No. 61/371,157, entitled “Call Features in a Non-Mobile Telephone System,” filed Aug. 5, 2010 which are expressly incorporated by reference herein.

### FIELD OF INVENTION

This invention relates generally to telecommunication systems, and more specifically to non-mobile telephone systems.

### BACKGROUND

Mobile smartphones have many applications for the personal use of the user on the device itself. They have convenient small touchscreens but, keyboards can be quite small for entry of input with human fingers. Shortcuts in language which have developed due to the small keyboards on mobile communication devices may not be understood or appropriate in a business environment. These factors make the mobile telephone non-ideal for many business environments.

Non-mobile telephones, for example desktop or office phones, are still preferred by many in the office environment. For example, they have better speaker phone and sound quality.

General purpose computers with regularly-sized keyboards, mice, and displays make navigating numerous documents easier, a task typical in an office environment.

Although the aforementioned devices have different advantages, they are not integrated to provide services, particularly in an office environment.

### SUMMARY

Technology is presented for a non-mobile telephone system. In one embodiment, the non-mobile telephone system comprises a graphical user interface which provides visual displays to assist a user in selecting call features and business applications. An example of a call feature is a call back functionality. In another example, a service request call feature allows a user to request a service like a taxi or package delivery or a reservation using the user interface of the non-mobile telephone system.

Technology is also presented for a non-mobile telephone system controlling the sharing of data stored on another computer system, in volatile or non-volatile memory, with a caller on the other end of a call with the non-mobile telephone system. In one embodiment, the non-mobile telephone system causes the data for sharing to be sent to a computer resource location, and provides resource access information for the caller to access the shared data at the location. An example of a sharing data is sharing a screen of the other computer system or sharing a file stored on the other computer system. The non-mobile telephone system can be paired with the other computer system to increase security. In one embodiment, the sharing is initiated by the non-mobile telephone system. In some embodiments, the sharing can be limited to the duration of a call so when the user ends the call, the sharing automatically ends with it.

In other embodiments, when the call is to a non-mobile telephone system which supports sharing, the data can be sent over the network connection connecting the call to a non-mobile telephone system of a caller. Sharing services software on the caller's non-mobile telephone system can route the received shared data to a computer system accessible to the caller's telephone system. In one example, the accessible computer system is paired to the caller's non-mobile telephone system.

### BRIEF DESCRIPTION OF THE DRAWINGS

FIG. 1A illustrates an embodiment of a non-mobile telephone system with a user interface.

FIG. 1B illustrates another view of the embodiment of a non-mobile telephone system with a user interface illustrating a call log feature display.

FIG. 1C illustrates another view of the embodiment of a non-mobile telephone system with a user interface illustrating a keypad.

FIG. 1D illustrates another view of the embodiment of a non-mobile telephone system with a user interface illustrating a contacts feature.

FIG. 1E illustrates another view of the embodiment of a non-mobile telephone system with a user interface illustrating a messages feature.

FIG. 1F illustrates another view of the embodiment of a non-mobile telephone system with a user interface illustrating an applications view.

FIG. 2 illustrates an embodiment of system architecture for a non-mobile telephone system.

FIG. 3 illustrates an example embodiment of a non-mobile telephone computer system.

FIG. 4 is an example embodiment of a network environment in which a non-mobile telephone system can operate in accordance with the various embodiments described herein.

FIG. 5 is a flowchart of an embodiment of a method of pairing a non-mobile telephone system with another computer system.

FIGS. 6A, 6B and 6C illustrate examples of general purpose computer systems including displays and input devices.

FIG. 7A is a flowchart of a method embodiment for processing a call using an interprocessing system protocol independent of a particular telecommunications protocol.

FIG. 7B is a flowchart of a method embodiment for processing a call feature, call back processing in this example, using an independent protocol.

FIG. 7C is an example of a user interface display box requesting input from a user on how to process a call.

FIG. 7D is an example of a user interface display box including a call back reminder.

FIG. 7E is a flowchart of an embodiment of a method for processing a service request call feature.

FIG. 7F is an example of a user interface display box including logistics information for a service request.

FIG. 7G is an example of a user interface display box including an acknowledgement for a service request.

FIG. 8 is a flowchart of an embodiment of a method for a non-mobile telephone system controlling sharing of data of another computer system.

FIG. 9 illustrates a display view on a user interface of a non-mobile telephone system generated by sharing services software.

FIG. 10A is a flowchart of another embodiment of a method for a non-mobile telephone system controlling sharing of data of another computer system from the perspective of the telephone system initiating the sharing.

FIG. 10B is a flowchart of another embodiment of a method for a non-mobile telephone system controlling sharing of data of another computer system from the perspective of the telephone system initiating the sharing.

FIG. 11 illustrates a display view on a user interface of a recipient non-mobile telephone system generated by sharing services software.

### DETAILED DESCRIPTION

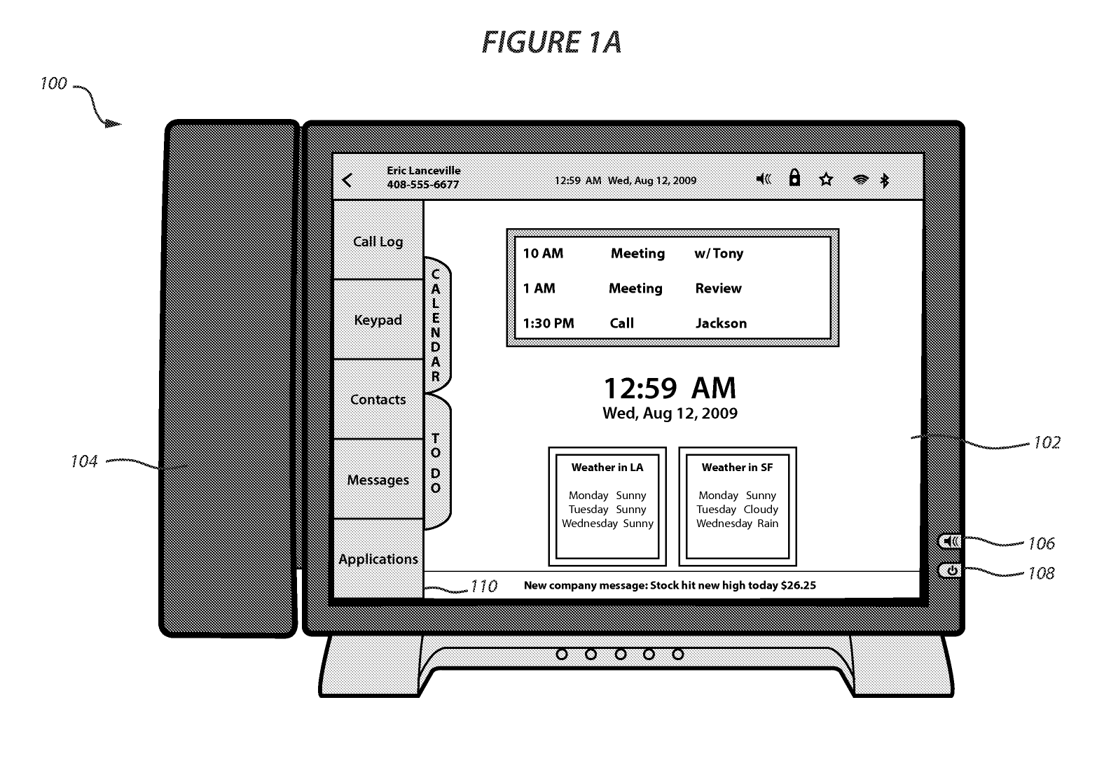

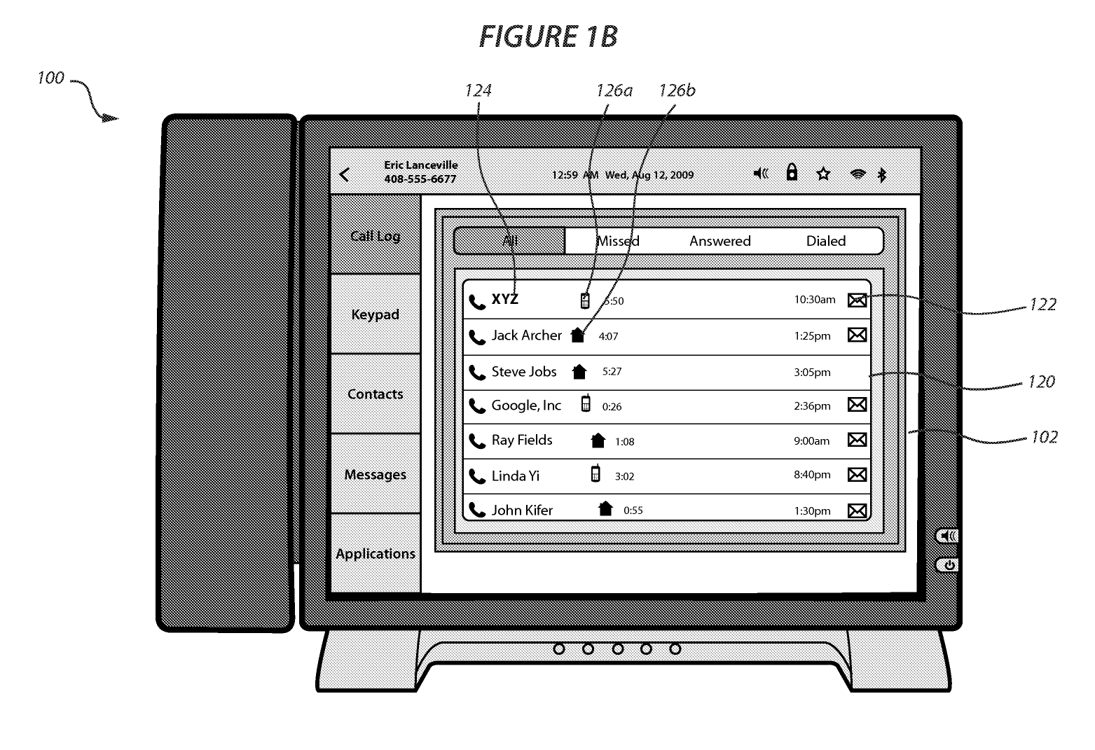

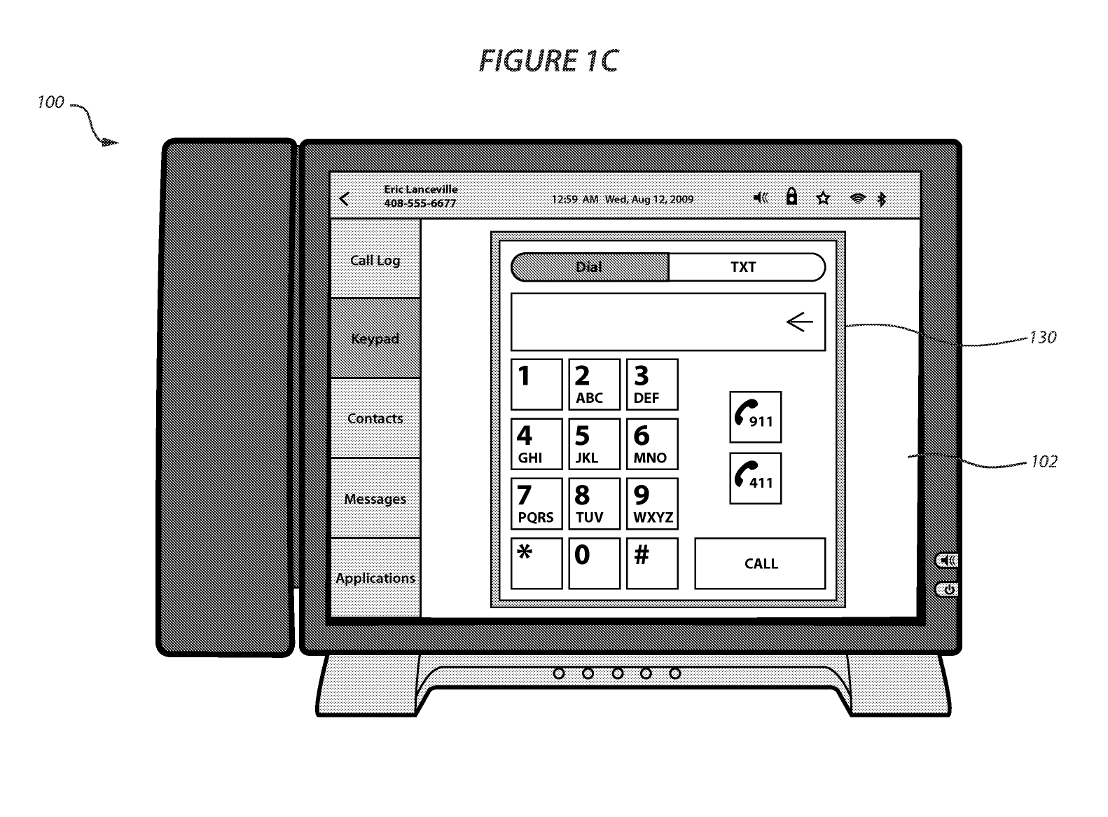

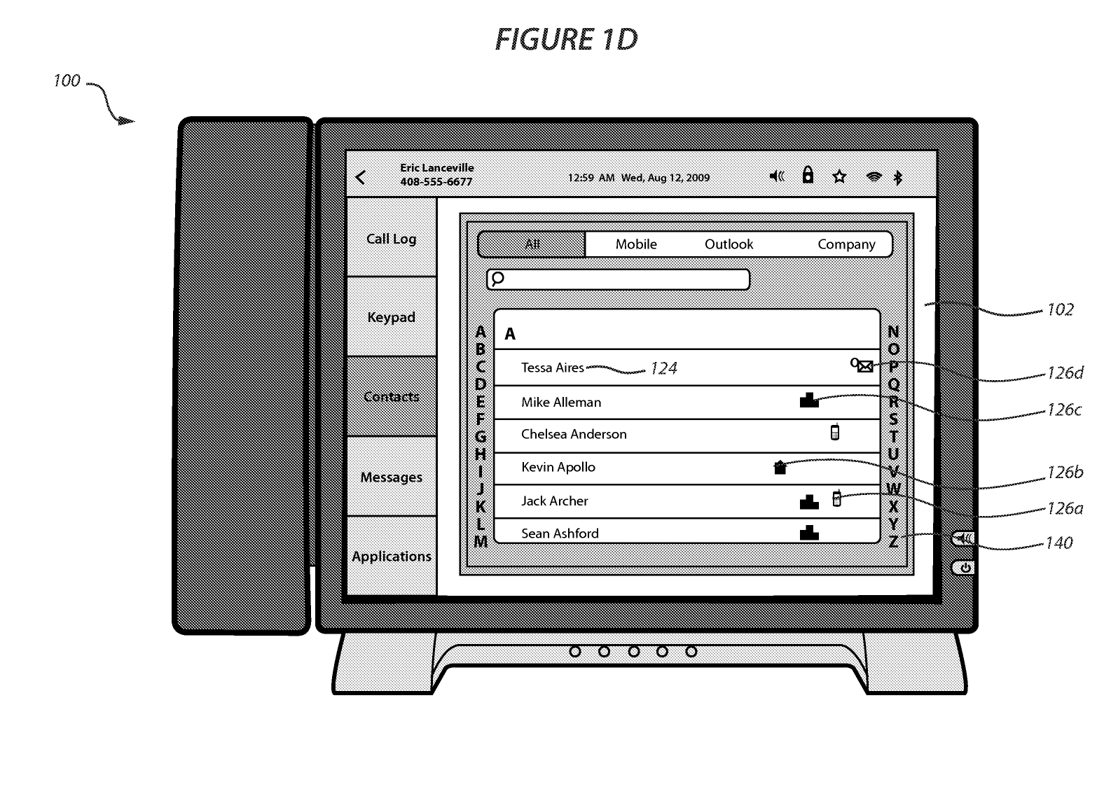

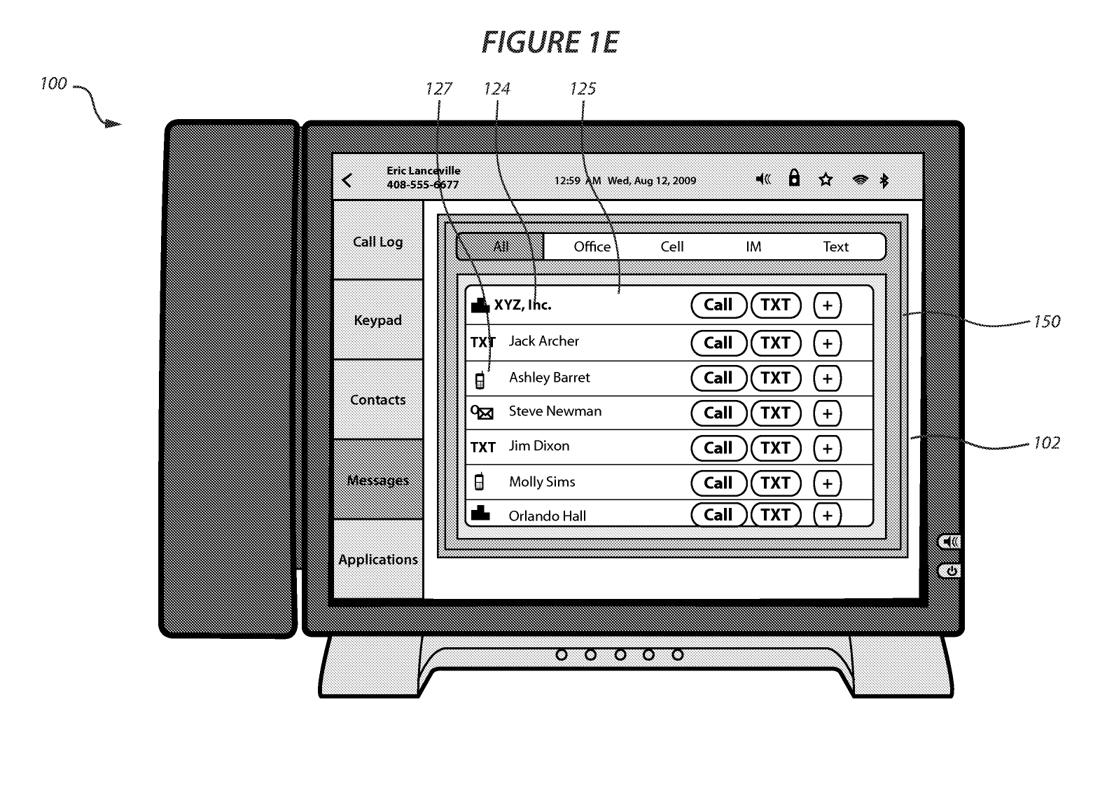

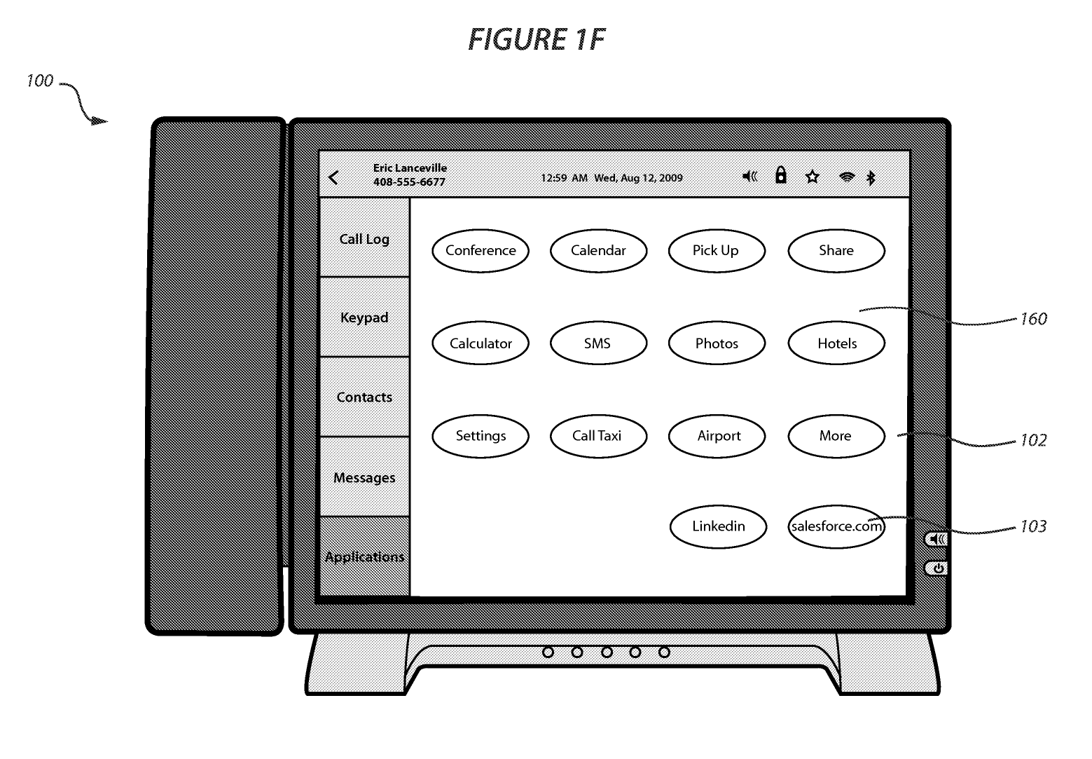

FIG. 1A illustrates an embodiment of a non-mobile telephone system 100 with a user interface 102. This illustrated embodiment is well-suited for use as a business or office desktop telephone. A non-mobile telephone system differs from a mobile communication device in a number of characteristics. For example, a non-mobile telephone is typically of a size that although it can be easily carried by a human from one desk to another like a desktop computer, can not easily fit in a purse or pocket for being constantly with a person like mobile communication devices such as cellular telephones, smart phones or personal digital assistants (PDAs). Non-mobile telephone systems such as desktop phones are adapted to be placed on, and possibly attached to, a supporting surface such as a table or wall, and to be operated while being supported by such a surface.

Furthermore, in some examples, a non-mobile telephone system can receive its voice signal data over a wired connection such as a Plain Old Telephone System (POTS) line or a Voice over Internet Protocol (VoIP) line connection and process the voice signals in these protocols. For example, the VoIP data representing voice signals may connect to the Internet via a wired Ethernet connection port to the non-mobile telephone system.

Some examples of non-mobile telephone systems do receive and process voice signals in a wireless communication protocol. An example of such a wireless communication protocol is Global System for Mobile Communications (GSM) or other cellular based communications protocols. In some countries, infrastructure improvement has been going into wireless technologies rather than expanding a limited land line infrastructure. Due to its remaining typically within a building, its reception even in a wireless protocol, can have a higher consistency of signal quality than a mobile communication device as it moves with a person.

Furthermore, non-mobile telephone systems for business use typically are connected to a type of private business exchange (PBX), such as a traditional PBX or an Internet Protocol PBX (IP PBX) or a hosted or virtual IP PBX for VoIP. Fixed location telephones using a mobile cellular communication protocol like GSM can also be linked to a type of PBX.

In an embodiment, non-mobile telephone system 100 comprises a handset 104 and a graphical user interface 102. As shown in FIG. 1A, user interface 102 includes a touchscreen. In an embodiment, the touchscreen is a color touchscreen of 800×600 16 bit color resolution. In the embodiment, the touchscreen is also eight inches across making it easy to manipulate with fingers or a handheld pointing device such as a pen for the touchscreen. In other embodiments, the telephone system can have an interface (not shown) for a pointing device such as a mouse and an interface (not shown) for a keyboard. In yet another embodiment where the non-mobile telephone system is paired with a general purpose computer system, pairing software allows a user to use a computer keyboard and mouse to update data for non-mobile telephone system 100.

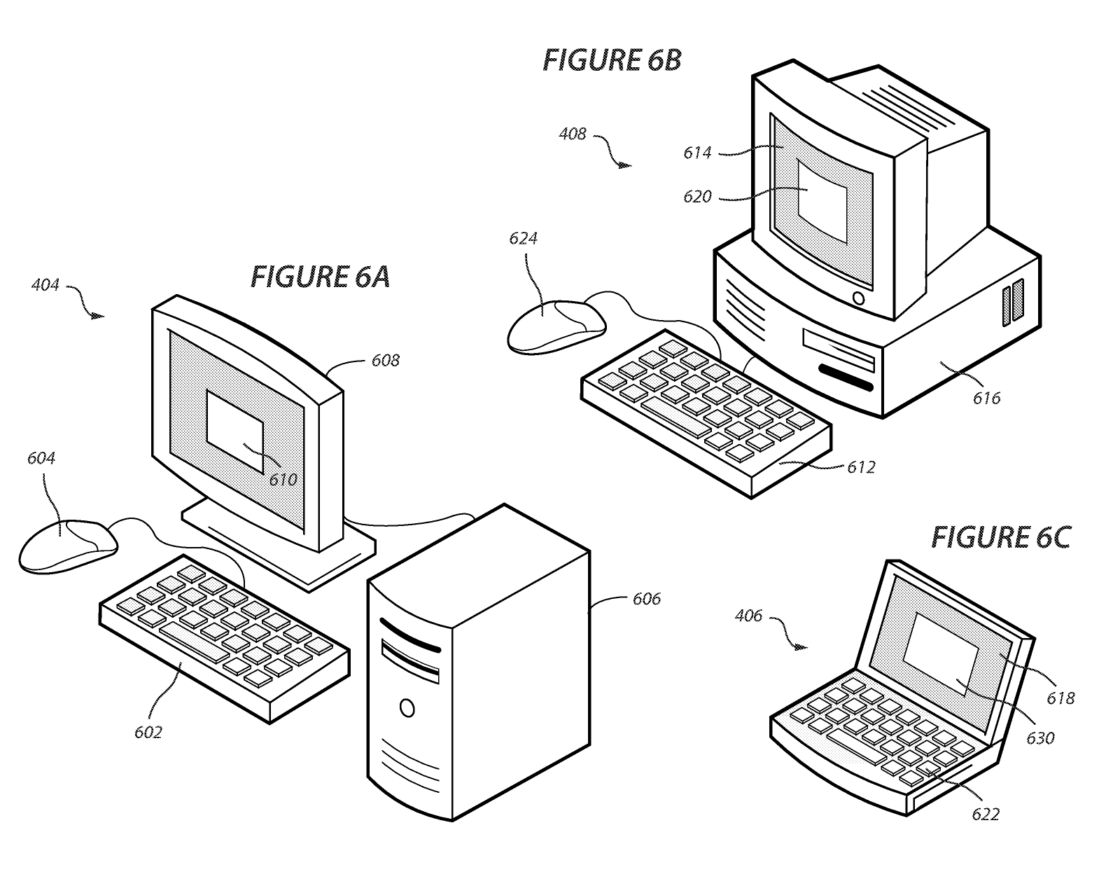

In another embodiment where the non-mobile telephone system is paired with a general purpose computer system, e.g. 408 in FIG. 6B, the pairing software allows a user to use the computer keyboard and mouse to update data for the telephone system 100.

Additionally, non-mobile telephone system 100 includes a “do not disturb” button 106 and an speaker phone button 108. Moreover, non-mobile telephone system 101 can use a Power over Ethernet or standard power adapter.

In an embodiment as shown in FIG. 1A, user interface 102 displays a side menu 110 including various feature selectors on the touchscreen display area of user interface 102 that a user can select with his finger or other pointing device. Examples of the feature selectors include a “Call “Log,” a keypad for typing in numbers, a “Contacts” selector for accessing contact information for various people or businesses, a “Messages” selector for selecting voicemail and text messages, a “Calendar” selector, a “To Do” list selector and an “Applications” selector for accessing call features and other services provided by the non-mobile telephone system. Currently displayed is calendar information as illustrated by the example “Mtg with Tony, discussing . . . ” at 10:00 A.M.

Moving on to the next figure, FIG. 1B illustrates another view of the embodiment of a non-mobile telephone system 100 with a user interface 102 illustrating a call log feature display 120. In this call log display 120, the caller's information including an identifier 124 such as a name or number which is displayed along with an indicator of from which number or type of telephone, (e.g. mobile 126a or non-mobile 126b) the call was made. Additionally, a message indicator 122 is displayed for those calls for which a voicemail message was left. In some instances, the message may be a text message produced by speech to text software. In other instances, it can be a regular text message.

FIG. 1C illustrates another view of the embodiment of a non-mobile telephone system 100 with a user interface 102 illustrating a keypad 130. In this example, a user can enter a number using the keypad and select the “Call” button to make the telephone dial the entered number. Additionally, “TXT” can be selected and a user can enter a text message using the keyboard of the office computer system via the pairing network (further described below). This text message is then transmitted to non-mobile telephone system 100, which can be used as an office phone, and subsequently transmitted to a mobile communication device (e.g. cell phone) via the cellular network of the mobile communication device.

FIG. 1D illustrates another view of the embodiment of a non-mobile telephone system 100 with a user interface 102 illustrating a contacts feature. In this contacts display 140, a contact's information including an identifier 124 such as a name or number is displayed along with an indicator of a telephone number and the type of telephone with which it is associated, (e.g. mobile 126a, home 126b, work or company 126c, or from a computer program such as Outlook® 126d). As shown, contacts from a mobile communication device, an e-mail or other contacts collection type software (e.g. Outlook®), and from a company directory can all be integrated for viewing on a single display 140. They can also be listed by their individual categories. The non-mobile telephone system 100 can download the mobile communication device contacts using a wireless or wired connection, and can download the e-mail contacts and company directory via a local area network connection.

FIG. 1E illustrates another view of the embodiment of a non-mobile telephone system 100 with a user interface 102 illustrating a messages feature. In this messages display 150, as shown, messages, both voicemail and text from a mobile device, represented in “Cell”, an instant messaging software application, represented in “IM”, voicemail for this phone represented in “Office” and text messages for this telephone, represented in “TXT” can all be integrated for viewing on a single display 150. They can also be listed by their individual categories.

An identifier 124 such as a name or number with which the message is associated is displayed along with an indicator of the message category in this integrated view 150. For example, the symbol 125 next to “XYZ” indicates a voicemail message was left at the telephone number associated with this non-mobile telephone system. The “TXT” symbol next to “Jack Archer” indicates a text message for him. The symbol 127 which looks like a cellular phone next to “Mike Armann” indicates a voice or text message on the user's mobile telephone in communication with this non-mobile telephone system (further described below). The “IM” symbol next to “Lynda Barrett” indicates an instant messaging message from messaging software which can be executing on a paired computer system (further described below).

Instant messaging is just an example. Other types of messages such as e-mail messages can be used as well. Also, voicemail messages can be represented as text using speech to text software if a user prefers as well. Messages can be incoming or outgoing messages or drafts as well.

It should be understood by one having ordinary skill in the art that instant messaging is just an example and that the present invention should not be limited thereto. Other types of messages such as e-mail messages can be used as well. Also, voicemail messages can be represented as text using speech to text software if a user prefers as well. Messages can be any of incoming or outgoing messages or drafts and this would be in the spirit and scope of the present invention.

Additionally, a user can select a manner to respond such as but not limited to placing a call, sending a text message, or responding in another manner provided by the message categories which displays when the user selects the “+” display button for more options.

FIG. 1F illustrates another view of the embodiment of a non-mobile telephone system 100 with a user interface 102 illustrating an applications view 160. A user selects a service, for example by touching, an application's selector or icon on the user interface display 102. Examples of different types of applications for services are represented by icons 103. For example, the “Conference” icon represents a kind of telephone service. The “Calendar”, “Calculator” “Photos” and “Settings” represent computer services and device control services. “Linkedin.com” represents an Internet based social or business networking service. Facebook, Twitter and MySpace are other examples. “Call Taxi,” “Hotels,” “Airport,” “FedEx PickUp,” “UPS PickUp,” and “Salesforce.com” represent examples of types of services, typically for business, that can be launched from non-mobile telephone system 100.

In this example, the icon “SMS”, can be selected by the user, in this case to send or read a text message. Also, in this example of FIG. 1F, a sharing activity can be initiated by the non-mobile telephone system responsive to a user selecting the “Share” icon in the Applications view 160.

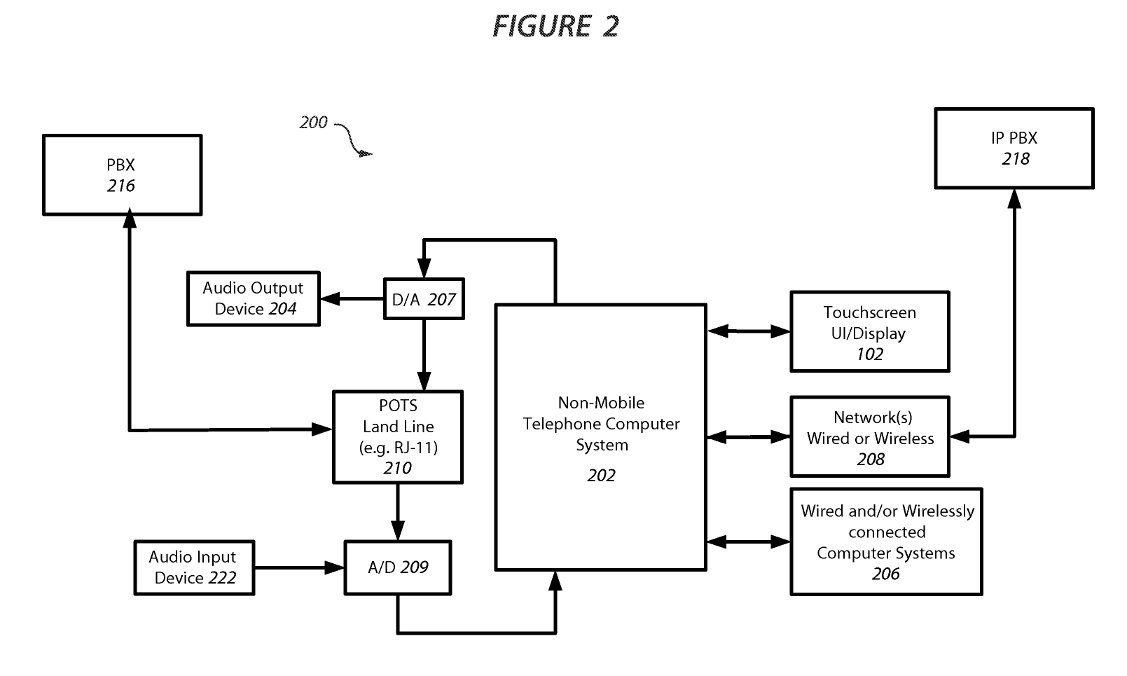

Continuing through the figures, FIG. 2 illustrates an embodiment of system architecture 200 for a non-mobile telephone system in accordance with an embodiment of the present invention. In the embodiment shown, the system architecture 200 comprises a non-mobile telephone computer system 202 for telephony processing and for executing applications.

Some examples of telephony processing include processing voice signal data in one or more telecommunications protocols, recording and storing messages, tracking call information such as numbers, time of call, time period of call, and performing calling features, for example, caller ID, call forwarding, and conference calling.

In the embodiment shown, non-mobile telephone computer system 202 receives Plain Old Telephone System (POTS) signals directed via a Private Business Exchange (PBX) 216 to POTS land line 210, an example of which is an RJ-11. Analog to digital conversion by analog to digital converter 209 of the voice signal is performed. In one example, the signal can be sent to a digital signal processor (not shown) in the non-mobile telephone computer system 202 for extracting the signals. Signal improvement techniques can be applied. With the voice signal data in digital form, it can be stored by a paired computer system or in non-mobile telephone computer system 202. Furthermore, call log data and messages data can be updated by non-mobile telephone computer system 202 for the call as well. The voice signal data can then be converted from a digital to an analog signal by a digital to analog converter 207 for output to an audio output device 204. Examples of an audio output device 204 consistent with the present invention include a handset phone speaker, a headset, or a no-hands speaker phone option.

The voice signal data of the user is captured via an audio input device 222, an example of which is a microphone like that in handset 104. This voice signal data is converted from analog to digital by an analog-to-digital converter device 209 and can also be digitally captured for storage and/or signal improvement. Furthermore, call log data and messages data can be updated by the computer system 202 for the call as well. The digital signal would then be converted back to analog via a digital-to-analog converter device 207 for transmission to the POTS land line 210.

Furthermore, in the embodiment shown, the non-mobile telephone computer system 202 supports voice signals not only in a POTS telecommunication protocol but also in Voice over Internet Protocol (VoIP) or other Internet based or all digital transmission based protocol. In this example, the system 202 receives VoIP packets from through an Internet Protocol Private Business Exchange (IPBX) 218 via one or more networks 208, wired or wireless. A processor in the system 202 extracts the digital voice signals from the VoIP packets and can also perform signal processing techniques such as decompression and filtering. The voice signal data is then converted to analog form for transmission to an audio output device 204. Similarly, voice signal data from an audio input device 222 is converted to a digital signal and encoded in VoIP packets for transmission.

Non-mobile telephone computer system 202 is communicatively coupled to the user interface 102 (touchscreen) according to an embodiment. The user interface provides output and input to and from the user to execute various software applications and functions provided by the system 202. In other embodiments not using a touchscreen, there can be an I/O controller in the system 202 for handling input from user input devices such as a keyboard or pointing device (e.g. mouse) and a display driver for the display.

In an embodiment, non-mobile telephone computer system 202 can communicate with other computer systems and devices 206 which are connected through a device connection port which can be for example a Universal Serial Bus (USB) port, or a wireless communication port, an example of which is a Bluetooth port.

Additionally, according to an embodiment, non-mobile telephone computer system 202 can be communicatively coupled to one or more networks 208 which can be wired or wireless. In an embodiment, non-mobile telephone computer system 202 can have a wired Ethernet port for connection to a local area network (LAN). For example, an Ethernet port may be dual-ported for an Internet connection for the LAN to the telephone computer system 202 and in addition, may provide a connection from a non-mobile telephone system, in accordance with the present invention, to a general purpose computer system 206.

Non-mobile telephone computer system 202 can also include a wireless port for communicating according to a wireless communication protocol. Examples of wireless network protocols may include any of Bluetooth, a Worldwide Interoperability for Microwave Access (WiMax), or a version in the IEEE 802 set of standards for wireless communication, examples of which are the 802.11 set and the 802.16 set (which includes WiMax) and this would all be in the spirit and scope of the present invention.

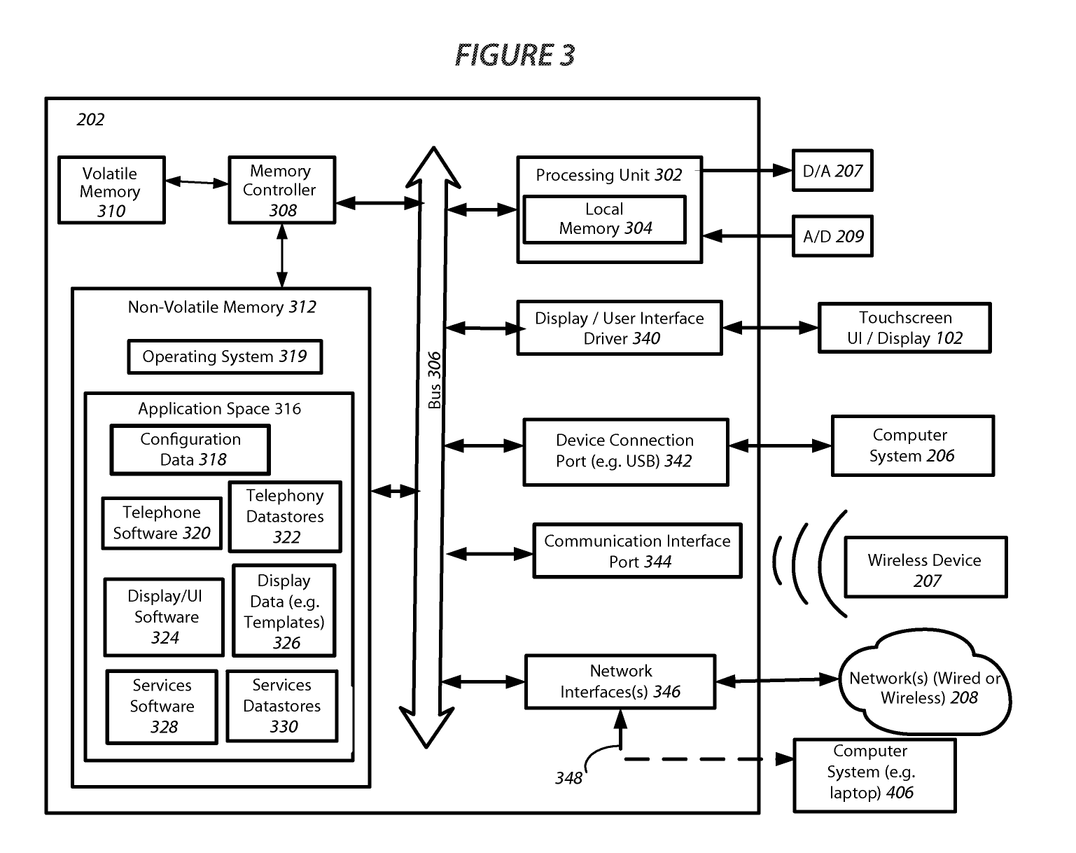

FIG. 3 illustrates an example embodiment of a non-mobile telephone computer system 202 includes computer hardware and software components. As shown, non-mobile telephone computer system 202 comprises a processing unit 302 including local memory 304. Processing unit 302 can comprise one or more processors. In an embodiment, at least one of the processors can be dedicated to processing voice and data encoded in a particular telecommunication protocol. For example, voice and data signals can be embodied according to POTS standard, or in accordance with a cellular protocol like GSM or Code Division Multiple Access (CDMA), or in accordance with Voice over IP (VoIP).

Processing unit 302 may include a VoIP processor, a digital signal processing processor (DSP) and a multi-purpose microprocessor. In an embodiment, an Audiocodes® processing device can be used which includes a VoIP and DSP Processor as well as voice codecs and which supports Session Initiation Protocol (SIP, an IETF-defined signaling protocol, widely used for controlling multimedia communication sessions such as voice and video calls over Internet Protocol (IP). In yet another embodiment, an OMAP (Open Multimedia Application Platform) microprocessor can be included in processing unit 302 to perform the functions of a general purpose microprocessor and has capabilities for portable and mobile multimedia applications. Texas Instruments has developed a variety of these types of processors.

In the embodiment shown in FIG. 3, the processor(s) are shown having local memory 304 which can embody various cache designs to assist the one or more processors in the processing unit 302 with faster execution of instructions.

Bus 306 provides a communication path between the various system components. For example, the bus 306 provides the processing unit 302 with access to memory controller 308, which controls access in this example to volatile memory 310 and non-volatile memory 312. Volatile memory 310 is representative of the volatile storage such as random access memory (RAM) in its various technology implementations (DRAM, SRAM, etc.). Some examples of temporary data stored in volatile memory is data for use when an application is executing in processing unit 302 and what is currently displayed on a computer screen. Non-volatile memory system 312 is representative of memory that stores data even when the power source of non-mobile telephone computer system 202 is turned off. Some examples of such non-volatility stored data are applications such as the operating system 318 and other software and datastores.

The aforementioned types of memory in addition to removable storage media (e.g. disks, memory sticks, etc.) are examples of computer-readable storage media having encoded thereon computer-executable instructions for performing various methods in accordance with embodiments of the technology described in this specification.

In the embodiment shown, non-volatile memory 312 stores in an application space 316 software for controlling various functions in system 202. For example, non-volatile memory 312 includes telephony software 320 which can process VoIP packets if not handled independently by a VoIP processor. Telephone software 320 also handles telephone functions such as setting up calls, recording messages and storing them in the telephony datastores 322, collecting and storing call information such as time made, telephone numbers and associated contact information, and length of calls, and calling features like caller identification, caller ID, and call forwarding. Telephony software 320 also updates and stores such data as voice and text messages, contacts, and call log information such as call information in telephony datastores 322 in memory 312 so a user can retrieve them later when she enters commands via the user interface 102.

Telephony software 320 includes one or more telecommunication protocol (TP) interface agent(s) 336. Upon determination of what a requested call function or feature is, the telephony software 320 communicates the request to the appropriate TP interface agent(s) 336 which formats the request in a format usable by computer processing units in the processing unit 302 such as software, firmware and/or hardware used for communicating in a particular telecommunication protocol like the examples of POTS, VoIP, and GSM.

Additionally, according to an embodiment, telephone software 320 or a VoIP processor in the processing unit 302 can store non-voice signal data packets in volatile memory 310, and notify operating system 319 which can then notify executing software or the executing software itself, that data accompanied the voice signal data and give its location in memory. Other manners of notifying an application of accompanying data can be done as well in view of the explanations provided here. A user can then be notified via user interface 102 of data in addition to voice signal data received for a call.

Configuration data 318 includes identifying information about non-mobile telephone computer system 202, such as its telephone number, network address, for example an IP address, and its media access control (MAC) layer address which can be used to identify non-mobile telephone computer system 202 by services software 328 which includes pairing service and capability such that the non-mobile telephone system joins with another computer system as discussed below. Other information may include a serial number for the telephone, a unique identifier separate from the telephone number, a packet identifying features the non-mobile telephone system supports such as a display and touchscreen interface. Moreover, configuration data 318 may also include information such as a network address and a MAC address of a computer system with which can be used to pair with another computer system (further described below). Furthermore, the data 318 can include one or more encryption keys and passwords for security.

Non-mobile telephone computer system 202 also includes display and user interface software 324 receives user input from the display and user interface driver 340 over bus 306. In an embodiment, driver 340 controls the touchscreen 102 portion of the user interface of the non-mobile telephone computer system 202 which relates the user's touches on the screen to commands and sends the commands to the display and user interface software 324.

The display and user interface software 324 can determine a display to generate based on a display data template 326. In other embodiments, display and user interface software 324 notifies an application, for example, the telephony software 320 or other services software 328 of a user command. In yet another embodiment consistent with the present invention, display and user interface software 324 notifies multiple services software applications of a user commands and the notified software can provide information to be used in a display or request user input. In return, the display and user interface software 324 incorporates a request or provided information in a display which it can build based on a display data template 326 or unique display view provided by an application. The display data is then sent to the display driver 340, in an embodiment via bus 306, for display on a user interface 102 (e.g. touchscreen).

Furthermore, the services software 328 provides functions such as pairing non-mobile telephone computer system 202 with one or more other computer systems and transferring data and functionality between them as discussed further below. Services software 328 may also include can be call features and business applications, as shown in FIG. 1F. In cooperation with services software 328, services datastores 330 can also store pertinent information to perform various services.

The embodiment shown in FIG. 3 further includes a device connection port 342, for example, a USB port, for attaching to another computer system such as a mobile communication device or a laptop computer, or a personal computer. In addition, FIG. 3 includes a wireless communication interface port 344 for connecting with a wireless device 207 according to a wireless communication protocol such as Bluetooth. Communication interface port 344 can be a direct wireless connection port or also can be a network wireless communication port (e.g. 346). Again, some examples of a network protocol are Bluetooth, WiMax or other IEEE 802 varieties of wireless protocols.

One or more network interface(s) 346 are also provided so that a non-mobile telephone system, in accordance with the present invention, can integrate into one or more computer networks 208. Network interface(s) 346 may include both wired and wireless interfaces. In an embodiment, network interface(s) 346 may include a dual-ported interface 348 such as an Ethernet connection. The non-mobile telephone computer system 202 can be the connection point with a network, and can communicate network traffic through another port to a computer system.

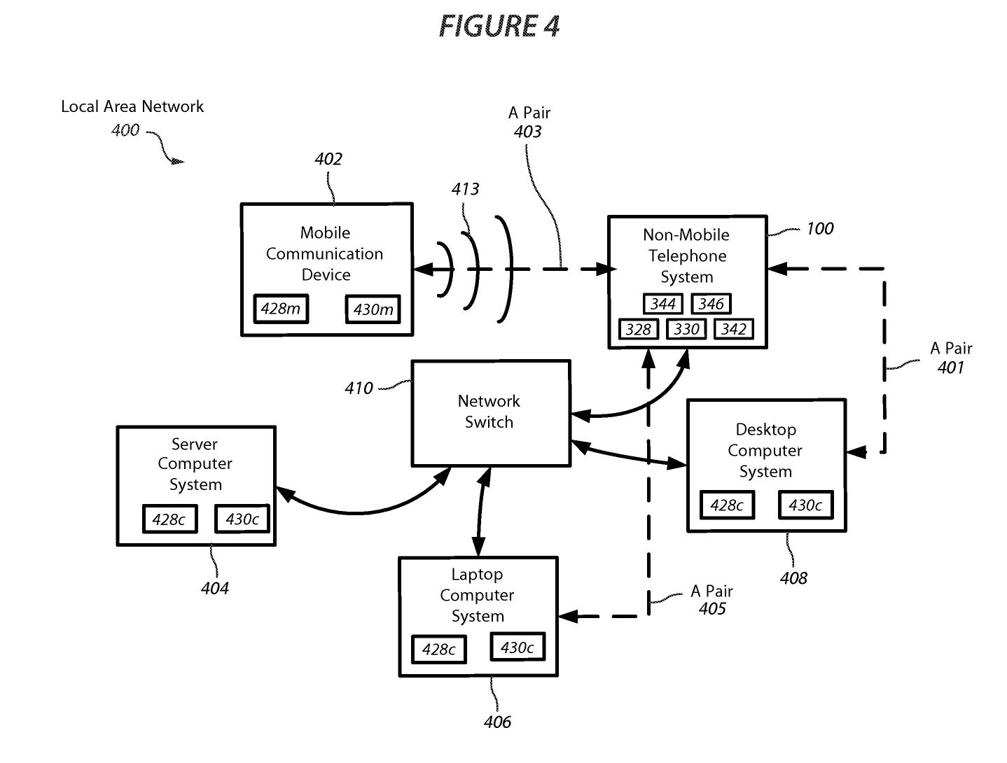

FIG. 4 is an example embodiment of a network environment in which a non-mobile telephone system in accordance with the various embodiments described herein can operate. As shown, FIG. 4 illustrates a network linking a mobile communication device, a non-mobile telephone system, and a general purpose computer system. The network environment comprises a local area network 400 in which a non-mobile telephone system 100 is communicatively coupled to a network switch 410, some examples of which are a switch or a router. Three general purpose computer systems 404, 406, and 408 are also communicatively coupled to the network switch 410. The non-mobile telephone system 100 shown in FIG. 4 is communicatively coupled to a mobile communication device 402. The dashed arrows 401, 403 and 405 represent logical pairings between non-mobile telephone system 100 and three other computer systems 402, 406, and 408.

The telephone system 100 is paired in a pair 403 with mobile device 402 via a wireless protocol (e.g. 413). In this example, a Bluetooth pairing connection 413 with the mobile device 402 is made via a communication interface port 344 of the non-mobile telephone system 100.

Any known Bluetooth pairing technique can be used. For example, two pairing devices can create and store a link key which lets each device authenticate the identity of the other paired device. Furthermore, the data transmitted between the devices can then be encrypted to prevent electronic eavesdropping. A user can initiate pairing by entering a personal identification number or password on the mobile communication device 402 to activate the Bluetooth pairing. In another example, Secure Simple Pairing (SSP) can be used. Other wireless protocols besides Bluetooth can also be used. In yet other embodiments, the mobile communication device can also connect to the non-mobile telephone system 100 via a wired connection.

Non-mobile telephone system 100 can provide services in cooperation with computer systems and mobile communication devices via services software 328 and services associated data 330. Mobile communication device 402 has services software 428m and data 430m to instruct it to perform its functions in providing these services. Mobile communication device 402 services software 428m communicates with the non-mobile telephone system's 100 services software 328.

As mobile communication device 402 communicates in cellular network protocols like Short Message Service (SMS), its version of the software can be different than that for the general purpose computer systems shown 404, 406 and 408. The exemplary examples of a general purpose computer system are a server computer system 404, a laptop computer system 406, and a desktop computer system 408. Each of these general purpose computer examples includes services software 428c and associated data 430c. The software 428c on the computer systems 404, 406, and 408 communicates with services software 328 on non-mobile telephone system 100.

In an embodiment, mobile communication device 402 can transfer data in a mobile cellular transmission format, for example, a SMS format which processing unit 302 can process. For example, a SMS service application can be supported on an OMAP microprocessor component within the processing unit 302. A general purpose computer system like the examples shown can be communicatively coupled to the non-mobile telephone system 100 via a network interface 346 as shown or can be connected wirelessly (e.g. 344) or by a direct wire connection (e.g. 342).

By pairing a non-mobile telephone system 100 with a mobile communication device 402 and with a general purpose computer system 404, 406, 408, services software 328, 428m and 428c can leverage features of the different systems to provide services to a user as an integrated system. Additionally, since non-mobile telephone system 100 can be paired with the general purpose computer system in a pair and simultaneously be paired with a mobile communication device in another pair, the non-mobile telephone system can create a system, platform, or network integrating the aforementioned computer systems. As such, an integrated system or platform or network allows a user to leverage the different features of the different types of computer systems.

A feature can be hardware, software or a peripheral of a computer system so long as they operate in accordance with the present invention. Some other examples of a feature are a network connection, a supported communication protocol, a supported communication format, or storage type and storage amount available to a computer system. For example, a feature can be software running on a computer system, a display, a keyboard, or the ability to communicate in a cellular communication network protocol.

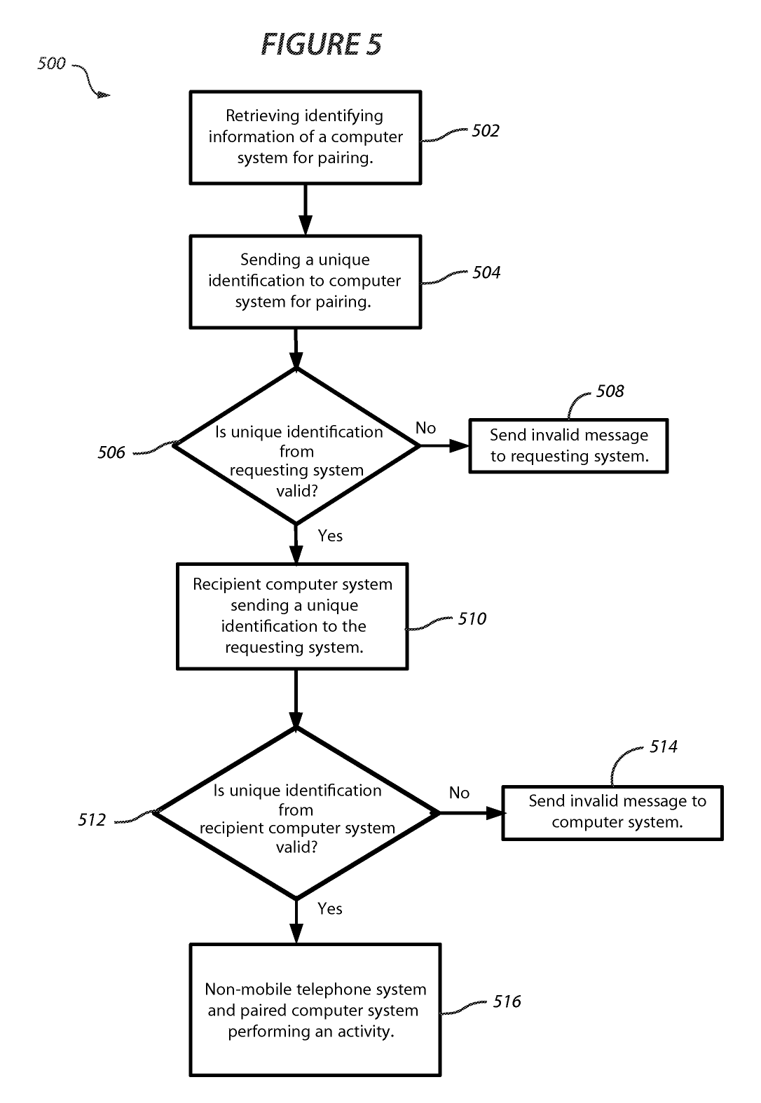

In an embodiment, non-mobile telephone system 100 can pair so that data is only shared from a specific computer system in a network which enhances security and privacy in the network. As shown in FIG. 4, non-mobile telephone system 100 is paired (a pair 401) with a desktop computer system 408. FIG. 4 further illustrates pair 405 which pairs non-mobile telephone system 100 and laptop computer 406. In an embodiment, pairing provides a service for which a service software application can be included in the services software 328 on non-mobile telephone system 100, in the software 428m on a mobile communication device 402, and in the software 428c on a general purpose computer system (e.g. laptop and desktop computer systems 406, 408). The method embodiments of FIGS. 5-7E are discussed in the context of the systems of the previously described figures for illustrative purposes only and not to be limiting thereof.

FIG. 5 illustrates a flowchart 500 of a method embodiment for pairing a non-mobile telephone system with another computing system. In an embodiment, a non-mobile telephone system consistent with the present invention can initiate pairing with another computer system or alternatively, a computer system can initiate pairing with the non-mobile telephone system if desired. In the following discussion for ease of illustration, the non-mobile telephone system 100 is the requesting system, and the example desktop computer system 408 is the recipient computer system. As the method embodiment of FIG. 5 is described, reference to FIGS. 3-5 will be made.

In an embodiment as shown in block 502 of FIG. 5, pairing software which is part of services software 328, 428c retrieves identifying information of the desktop computer system 402 for pairing while executing in non-mobile telephone system 100. In the embodiment, the identifying information can be stored in configuration data 318 in non-volatile memory 312 accessible by the processing unit 302. In other embodiments, the pairing software can broadcast a message in the network to other pairing software 328, 428c on other computer systems requesting them to send a unique identification which can be verified for a successful pairing partner. For example a user can provide a password on the computer system with which she intends non-mobile telephone system 100 to perform an activity, and an encrypted version of the password can be sent to the pairing software.

The identifying information can comprise an IP address and/or a MAC address for one or more other computer systems having a pairing application 428c in the network. In addition, the identifying information can include a symmetric encryption key which can be used to verify a password a user must provide on the telephone system user interface 102, a computer system, or both to complete a pairing, if desired.

As shown by block 504, the non-mobile telephone system sends a unique identification to the computer system over the network to form a pair. The unique identification can be a password for example, as mentioned above. In another example, it can be an extension number of the telephone. In another example, it can include an IP address, a MAC address, or both. The unique identification can be encrypted. There can be concatenation and encryption of two or more of these types of information as well to make the unique identification.

According to block 506, pairing software on a recipient computer system 408 determines whether the unique identification received is valid. For example, it can perform decryption using a key and can verify data against a key in its configuration file. According to block 508, if the unique identification is determined to be invalid, an invalid message is sent to the requesting system, in this example non-mobile telephone system 100. If it is valid, the recipient computer system sends a unique identification to the requesting system, non-mobile telephone system 100 for further verification, according to block 510. Moving along, block 512 provides that non-mobile telephone system 100 determines whether the unique identification from the computer system is valid, for example, determining validity may be based on configuration data stored within non-mobile telephone system 100. Non-mobile telephone system 100 can use similar techniques as the computer system used to verify its unique identification.

In an event that the unique identification is determined to be invalid, non-mobile telephone computer system 100 sends an invalid message to the computer system according to block 514. Otherwise if it determined to be valid, the non-mobile telephone system and the paired computer system can perform an activity as indicated by block 516.

In other embodiments consistent with the present invention, single pairing can be configured such that non-mobile telephone system 100 and a computer system can only be in one pair at a time. In other embodiments, multiple pairs can be allowed as illustrated in FIG. 4 where non-mobile telephone system 100 is in a pair 401 with the desktop computer system 408 in addition to being paired (e.g. a pair 403) with mobile communication device 402.

Pairing can be used to provide services. For example, as previously mentioned, a non-mobile telephone user can use the keyboard and mouse of a paired general purpose computer system to enter data in the non-mobile telephone system 100. Additionally, the user interface 102 can be identified as another display for a computer system (e.g. computer system 408 in FIG. 4) so that a keyboard (e.g. 702 in FIG. 6B) and mouse 704 can move items from the user interface 102 to the screen of a computer monitor and modify them or navigate and update items directly displayed on the user interface 102.

General purpose computer systems such as desktop computer systems, laptops and even netbooks tend to have larger keyboards and displays than telephone devices, non-mobile or mobile, which make input and output easier for a user. For example, it may be easier and more convenient for a user to view a shared screen of another computer on a computer monitor, a laptop screen or even a netbook screen. Additionally, manipulating a shared document is easier using a larger keyboard such as a standard keyboard, some examples of which are a 101 key US keyboard or 104 key Windows® keyboard, or a laptop or netbook keyboard. Additionally, a mouse of a standard size for use with a standard keyboard or one of the other types of general purpose computer system keyboards allows easier manipulation of data then thumb-sized input devices of mobile devices or even the touchscreen of the non-mobile telephone system. Furthermore, being able to store mobile messages and calls on a server or other general purpose computer system also alleviates memory constraints of a mobile device or desktop non-mobile telephone system.

FIG. 6A illustrates an example of a general purpose computer system 404 including a server 606 and peripherals of a liquid crystal display (LCD) 608, and input devices of a standard keyboard 602 and a mouse 604 of a standard size for desktop use. FIG. 6B illustrates an example of a general purpose computer system 408 including a desktop computer 616 and peripherals of a computer monitor 614, a desktop mouse 624 and a standard keyboard 612. These displays tend to be at least several inches in diagonal. Each of the displays includes a display area 620. Additionally, an example of a document displayed on a screen that can be shared is represented by display area 620. FIG. 6C illustrates an example of a general purpose computer system 406, in this example a laptop 406 which includes a laptop keyboard 622, LCD 618 and display 630.

Those familiar with general purpose computer systems like examples 404, 406 and 408 understand they have processors, memories, input output controllers, network interfaces, display drivers among other things and store and execute software including system level software like an operating system and various applications including display software, text editors and services software 428c.

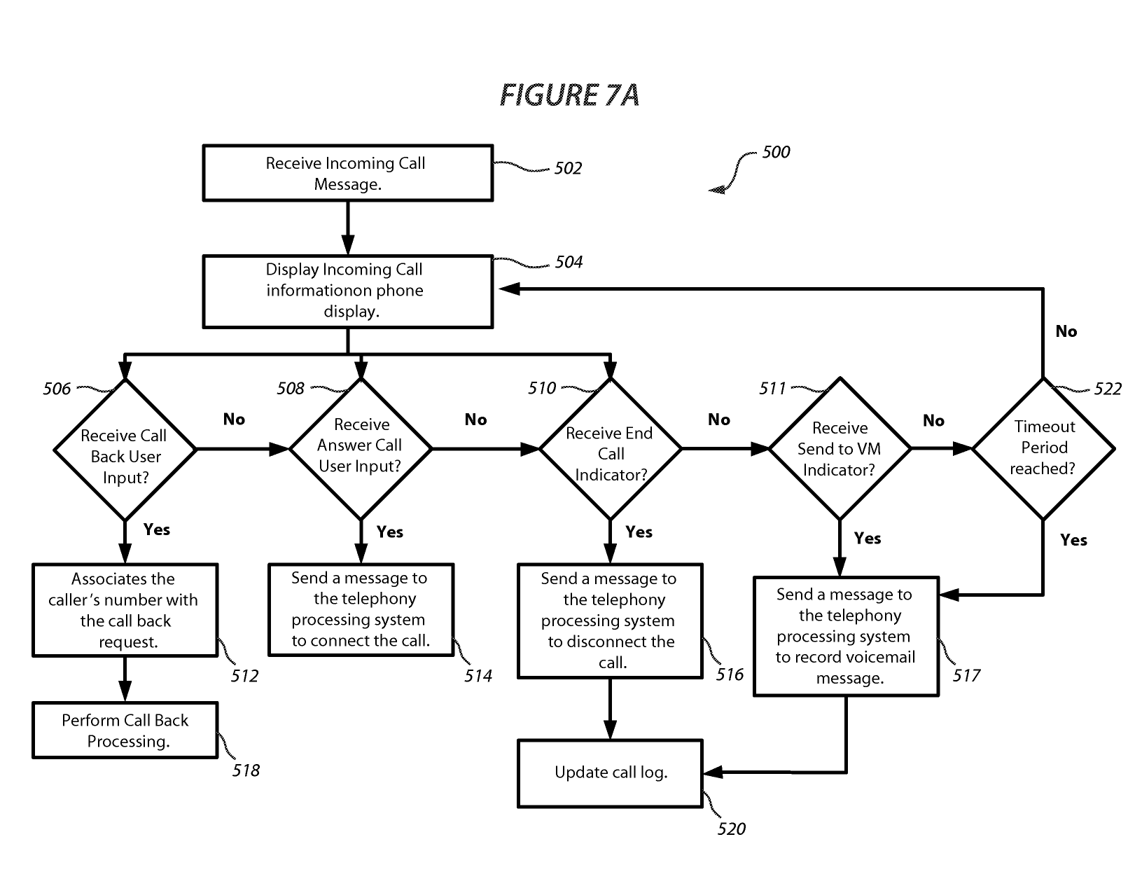

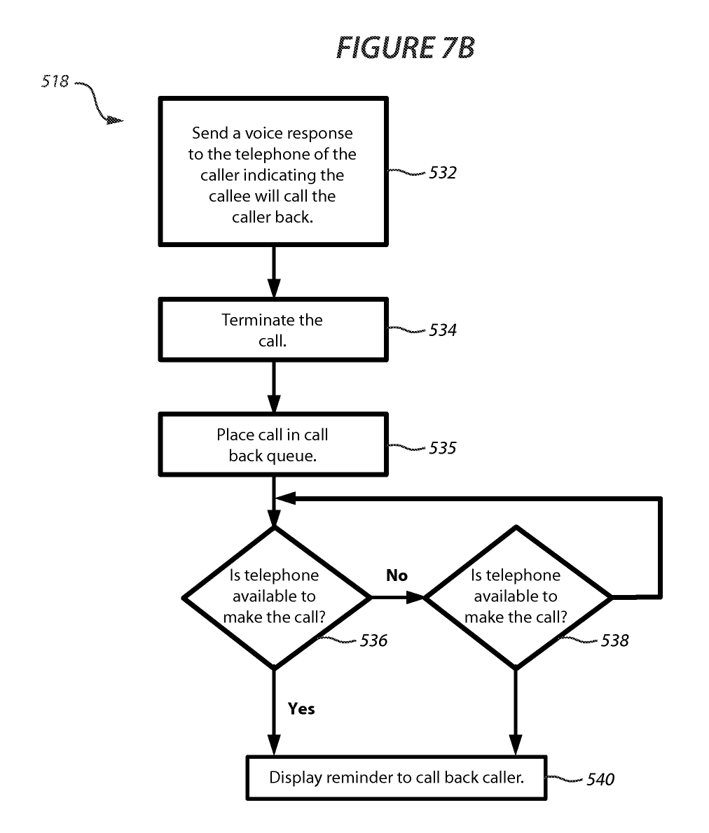

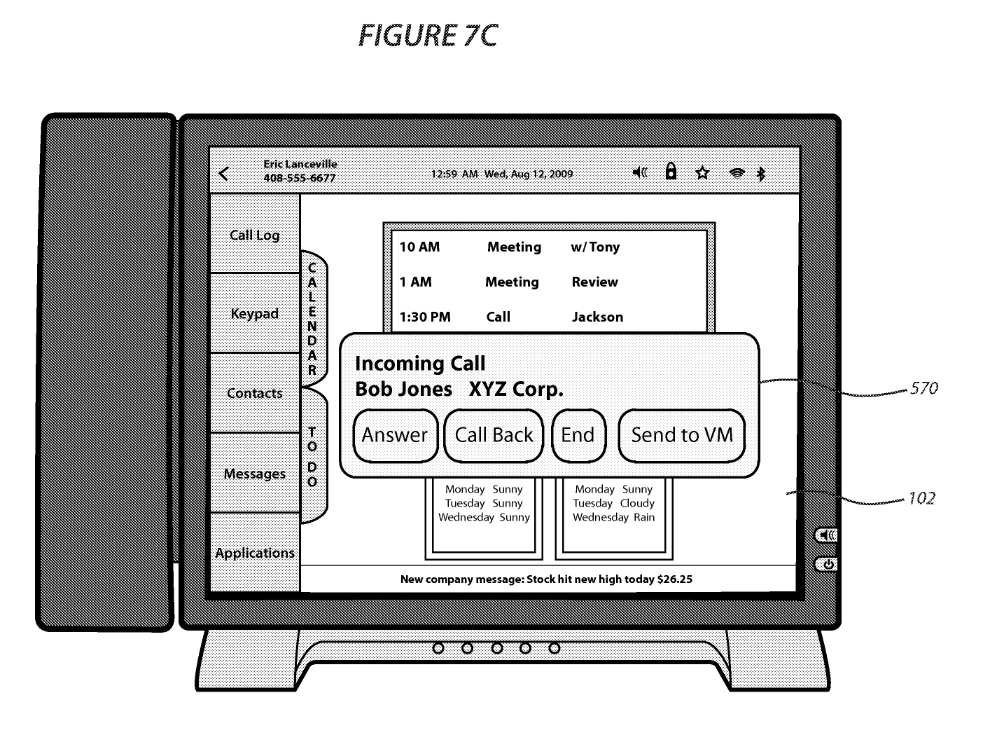

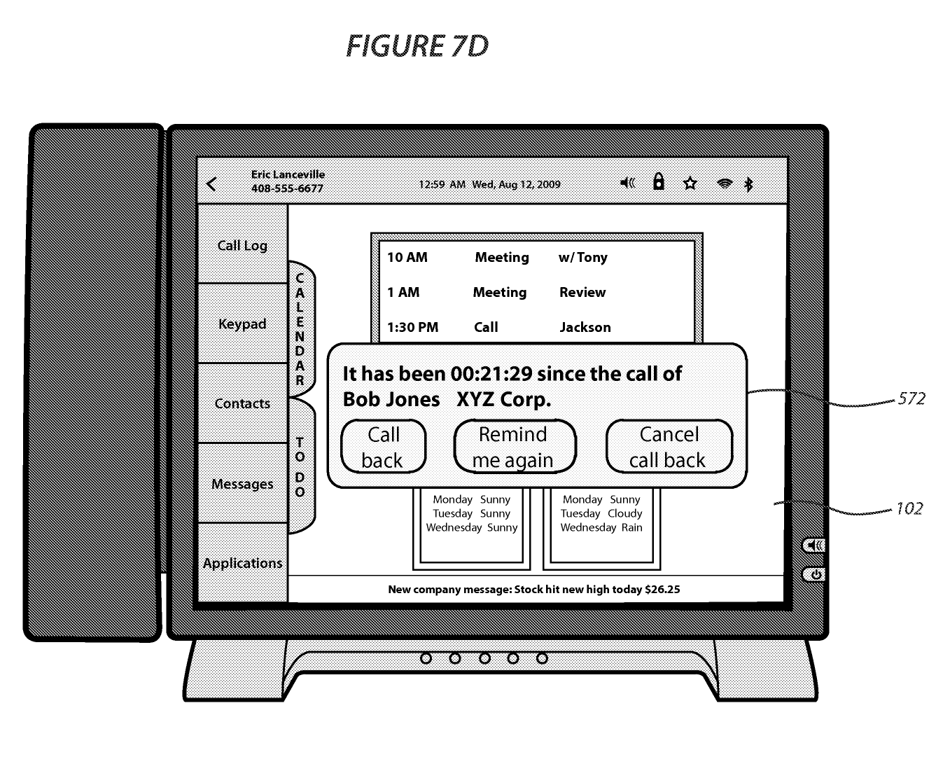

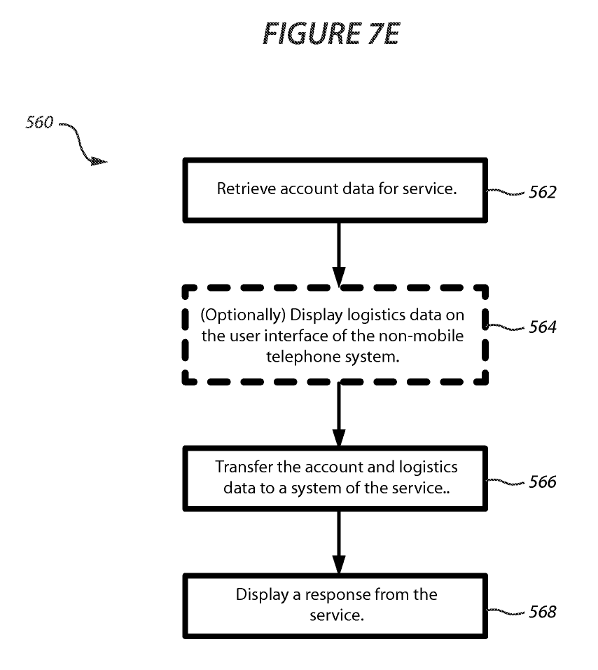

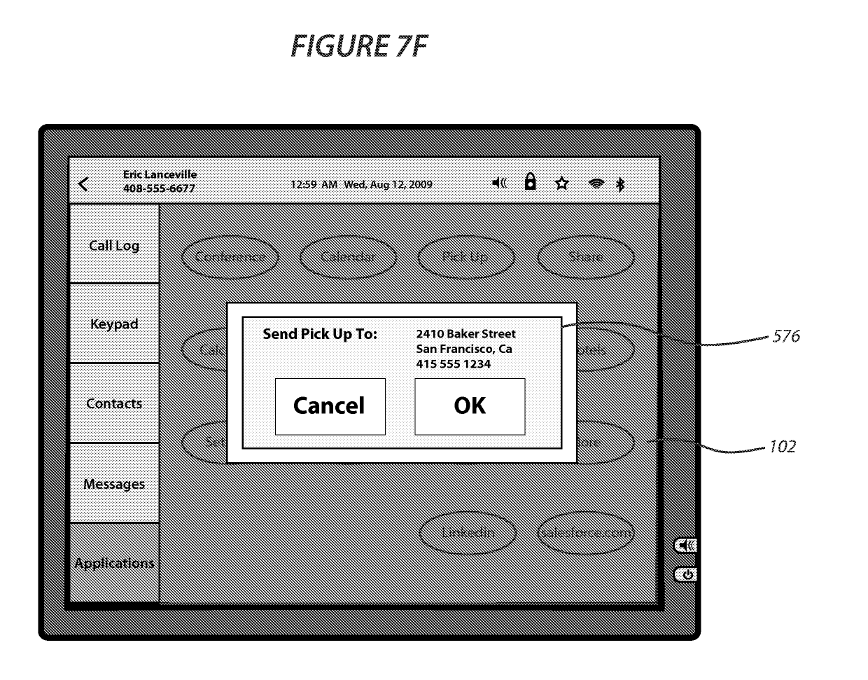

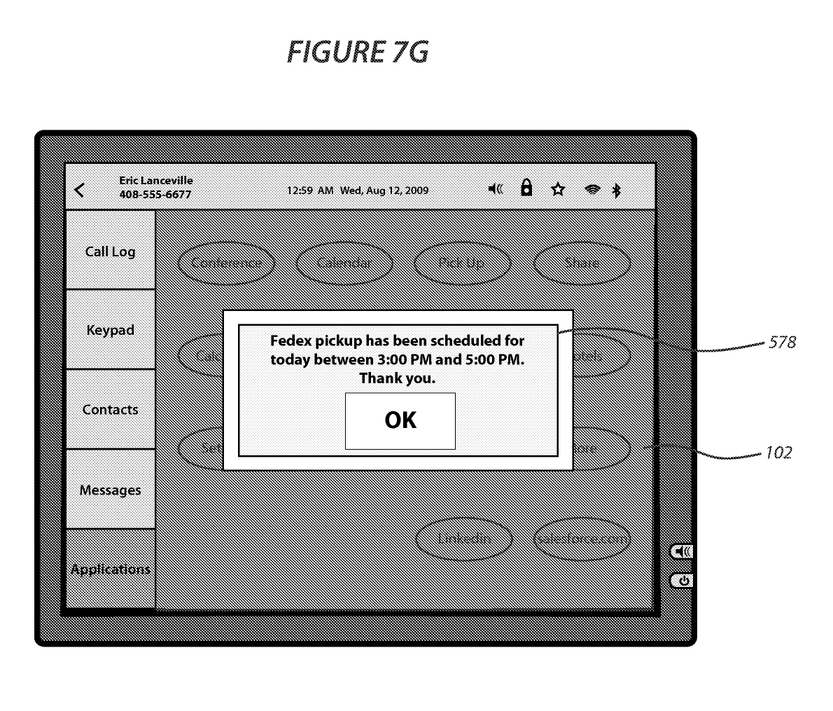

FIG. 7A illustrates a flowchart 500 of a method embodiment for processing a telephone call. FIG. 7B illustrates a flowchart 518 of a method embodiment for processing a call feature, call back processing in this embodiment. The method embodiments of FIGS. 7A and 7B are discussed in the context of computer system 202 of FIG. 3 and non-mobile telephone system 100 of FIGS. 1A-1F for illustrative purposes only and not to be limiting thereof.

The telephony software 320 receives (block) 502 an incoming call message via one of its TP interface agents 336, and causes displaying 504 of incoming call information (570 in FIG. 7C) on the user interface 102 of the non-mobile telephone system 100 via the user interface driver 340. As illustrated in FIG. 7C, the user can select from a number of options to process the call. The user can select the “call back” display area, an “answer” display area, “send to VM” for sending to voicemail, and an “end call” display area. Responsive to the user selecting the “call back” display area (block 506), a call back services software 328 or the telephony software 320 associates (block 512) the caller's number with the call back request, and performs (block 518) call back processing (See FIG. 7B discussion below). Besides a user selecting a “call back” display area, another trigger for the call back function can be that the caller is on hold for a certain period of time.

Responsive to receiving user input to answer the call (block 508) by the user selecting the “Answer” display button, the telephony software 320 sends (block 514) a message via its TP interface agent 336 for the telecommunication protocol of the call to the appropriate processing unit of the processing unit 302 to connect the call. The user input to answer the call can be selection of the “Answer” display area or picking up the handset or selecting a speaker phone button if not already on another call.

Responsive to receiving (block 510) user input to end the call by the user selecting the “End” display button, the telephony software 320 sends (block 516) a message to the appropriate portion of the processing unit 302 to end the call and updates (block 520) the call log.

Responsive to receiving (block 511) user input to send the call to voicemail by the user selecting the “Send to VM” display button or a timeout period being reached (block 522), the telephony software 320 records (block 517) a message and updates (block 520) the call log, and the call log display to show a message indicator (e.g. message indicator 122 of FIG. 1B) next to the call in the call log display (e.g. call log display 120 FIG. 1B).

FIG. 7B is a flowchart 518 of a method embodiment for an example of call back processing. The telephony software 320 receives the call back message. The telephony software 320 sends a message including a “Call Back” command via the protocol type TP interface agent 336 to cause an automated voice response to be sent (block 532) to the telephone of the caller indicating the callee (the user) will call the caller back, and causes the call to be terminated (block 534) or ended. In another example, if the caller's telephone can receive text based messages, e.g. a cell phone or a similar non-mobile telephone, a text message can be sent instead of a voice based message. The telephony software 320 or a call back services software 328 places (block 535) the caller's call information in a call back queue which it stores in memory 310 and/or 312 for later retrieval. Responsive to determining (block 536) that non-mobile telephone system 100 is available to make a call, for example by receiving a message from the processing unit 302 that a line is available due to a call end, telephony software 320 or a call back services software 328 causes display driver 340 to display (block 540) a reminder to call back the caller. There may be several items on the display, and a call back reminder may be currently displayed but in the background. Telephony software 320 or a call back services software 328 causes the call back reminder to display in the forefront of the user interface as illustrated in FIG. 7D.

Even if the line is not available, if the telephone application 320 or call back application 328 determines (block 538) a call back period has ended, it causes the display driver 340 to display (block 540) the reminder to call back the caller in the foreground of the display.

FIG. 7D illustrates an embodiment of a user interface display box including a call back reminder. In the embodiment, reminder 572 is displayed in front of the calendar and other items on the display and indicates the time since the call in the call back queue, 21 minutes and 29 seconds, and the caller's identifying information of name and company. The user may select “call back” causing call back services software 328 to send a message to telephony software 320 to initiate a call to the caller associated with this call back item. The user can select “Remind me again” which causes the telephony software 320 or services software 328 processing the call back to wait another call back period. The user can also select “Cancel call back” causing the telephony software 320 or services software 328 processing the call back to remove the call from the call back queue.

FIG. 7E is a flowchart 560 of an embodiment of a method for processing a service request call feature. Some services are amenable to a “one-touch” service request format due to the constant nature of the product or service requested. For example, overnight delivery services from an office can qualify when items are consistently the same, for example, documents or a certain type of part. In Applications view 160 (see FIG. 1F), a user can select the “FedEx” icon, for example, and account information for the user's business and location can be sent in a message to a FedEx® office that ordinarily picks up from the user's business.

An overnight service application services software 328, responsive to user input indicating selection of a one-touch service request, retrieves (block 562) stored account data for that service from its own non-volatile memory 312 or from a computer system (e.g. computer 408 of FIG. 6B) communicatively coupled to non-mobile telephone system 100. In one embodiment, the computer system storing the account data is paired with a non-mobile telephone system consistent with the present invention. The overnight services software application module 328 can optionally display (block 564) a display box, like display box 576 in FIG. 7F, including logistics data such as the request information that the user can view and confirm on the user interface 102. Then the overnight services software 328 sends a message over the network interface 346 transferring (block 566) the account information and logistics data to a system of the service, in this case the local FedEx office. The overnight services software 328 receives an acknowledgement or response and displays (block 568) the acknowledgement or response, such as the display box 578 indicating FedEx will pick up between 3 and 5 p.m. (see FIG. 7G).

In one example, where the receiving system of the service, e.g. FedEx or taxi or hotel, is a similar non-mobile telephone system like that shown in FIGS. 1A-1F or is a system with counterpart software with functionality like telephone software 320 and/or services software 328 that can receive the message in a telephone call, services software 328 requests telephony software 320 to send the service request in a call. In the example of the service having a non-mobile telephone system 100 as well, telephony software 320 on service's phone (e.g. the phone at the local FedEx office) can process non-voice Internet traffic and parse its headers to identify messages for the service applications of the non-mobile telephone. Telephony software 320 can also track data packets, like those carrying the FedEx pickup request, associated with a telephone call. Telephony software 320 notifies overnight services software 328 on the service's non-mobile telephone system of the request message. The service's overnight services software 328 can then send a confirmation reply for display (e.g. display 578 of FIG. 7G) on the user's user interface display 102 as part of the call or in a separately made call.

In another example, the data can also be formatted by the particular services software 328 to be in an e-mail format or other text format for processing by a mail or text based application of the recipient computer system of the service.

In another example, if the system of the service at the other end is a telephone system that cannot process non-voice signal data, the overnight services software 328 can cause an automated voicemail message with the account and logistics data to be sent to the service's (e.g. taxi service, hotel service) telephone system via the telephony software 320. The service can then call back to confirm the request will be satisfied.

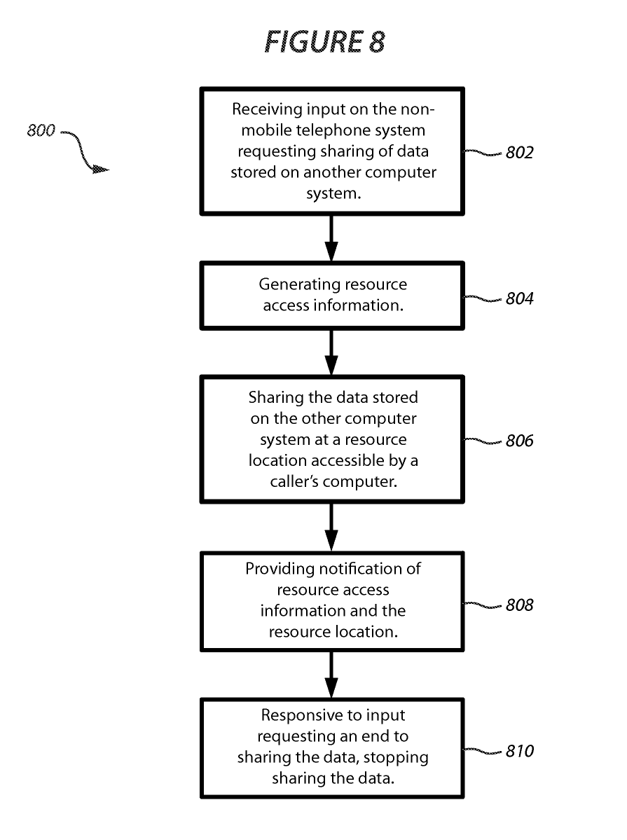

Sharing is an example of a service or activity for which a service software application can be included in the services software 328 on the telephone system 100, software 428m on a mobile device and on a general purpose computer system 428c. The method embodiments of FIGS. 8-10 are discussed in the context of the systems of the previously described figures for illustrative purposes only and not to be limiting thereof. Furthermore, in these examples, simply for illustrative purposes only, the term “caller” refers to a person on the other end of a call in which the non-mobile telephone system is engaged. The person operating the non-mobile telephone system is referred to as the “user.” Additionally, the user may be in a call with multiple callers.

FIG. 8 is a flowchart of an embodiment of a method 800 for a non-mobile telephone system controlling sharing of data stored on another computer system. The data can be stored in volatile or non-volatile memory. For security purposes, the computer system is likely to be in a pair with the non-mobile telephone system. The non-mobile telephone system receives (block 802) user input on the non-mobile telephone system requesting a sharing of data stored on the other computer system. For instance, in the example of FIG. 1F, the sharing activity can be initiated by the non-mobile telephone system responsive to a user selecting the “Share” icon in the Applications view 160.

In this example, the caller needs access information to a computer resource location to access the shared data. In other situations, the caller may already have access to the resource location. For example, in a call to an insurance company on a POTS telephone with no user interface, a caller may be logged in to his account information on a networked laptop. The user assisting the caller may want to show him her screen or allow him access to a file for information not ordinarily shown in his displayed view of his account records. Her screen can be displayed in a webpage associated with his account information. She does not need to send him resource access information such as a separate password as he is already logged into his account with a password he created.

The sharing services software executing on the non-mobile telephone or sharing services software 428c executing on a paired computer system (e.g. desktop 408) whose data is being stored can generate (block 804) resource access information. An example of resource access information is a password or information on how to receive a password or access code.

The computer system, for example a general purpose computer system like laptop 406, desktop 408 or server 404, shares (block 806) the data it stores at a resource location accessible by a caller's computer. The data can be stored in volatile memory like a current screen display. The sharing services software 428c can use commercially available screen sharing services software to share the data at the resource location. The data for sharing can also be an item stored in non-volatile memory like a document file. A resource location accessible by a caller's computer could be a storage location in the memory on a server. The storage location can be referenced, for example, by a uniform resource locator (URL). In one example, the shared data is posted on a website page which the caller can access with the resource access information.

The sharing services software 328 executing on the non-mobile telephone system 100 provides notification (block 808) of the resource access information and the resource location. For example, the sharing services software 328 causes the display software 324 to display a message to the user with this information on the user interface.

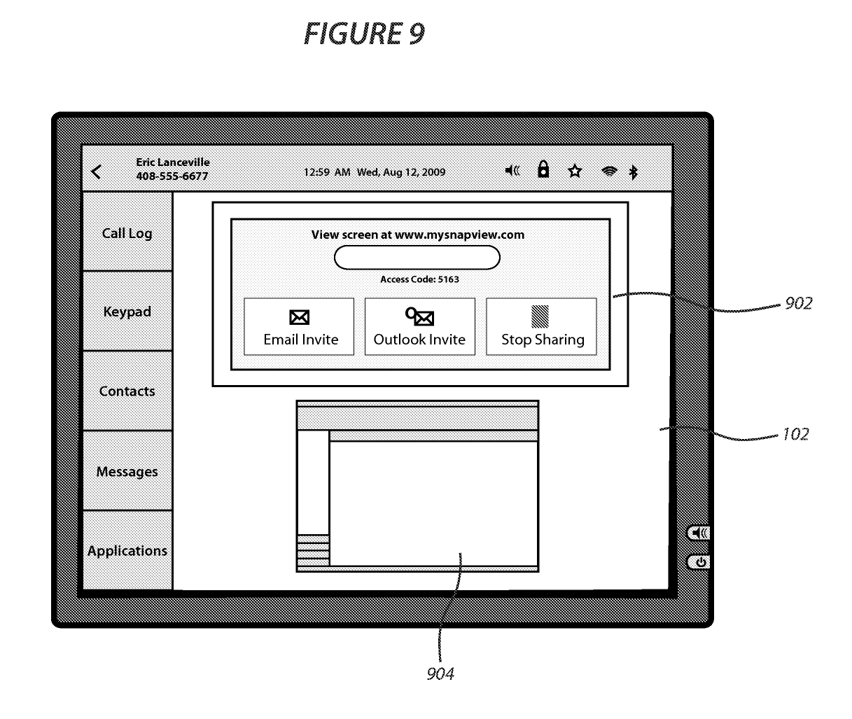

FIG. 9 is an example of a display generated by screen sharing services software 328. A display area 902 includes a website location, “www.mysnapview.com” and resource access information (e.g. the displayed “Access Code 5163”) which the user can speak over the telephone to a caller.

There are also “E-mail Invite” and “Outlook Invite” display buttons for the user to select in order to notifiy the caller of the resource access information and the resource location in an e-mail or text message or to look up the caller's contact information to do so. If the caller is calling on a telephone system like the non-mobile telephone system 100, software on the caller's system, for example, his version of sharing services software 328, can execute instructions to cause his user interface 102 of his recipient non-mobile telephone system to display the message with the resource access information and the resource location. The caller can then access the resource location, e.g. the URL of the website link in the message, with a networked computer system at his end and view the shared screen or other data from the user's other computer system.

The display area 902 provides a display button “Stop Sharing” for the user to provide user input to end the sharing of data.

In the display of FIG. 9, the sharing services software 328 also causes a displayed version 904 of the computer screen that the user is sharing at the resource location to appear on the user interface 102 of the non-mobile telephone so the user sees what the caller is seeing.

Responsive to input requesting an end to sharing of the data, the sharing services software 328 stops 810 sharing the data. In the example of FIG. 9, the user can select the “Stop Sharing” display button. Another form of input which can stop sharing of the data is ending the call, for example, by hanging up the handset or pressing an end call button or the caller hanging up. The telephone software 320 can provide notice of the hang-up. For example, it can update the call information in the telephony datastores 322 which the sharing services software 328 repeatedly checks. The telephone software 320 can also send or broadcast a message indicating the call ended to service applications like the sharing services software 328.

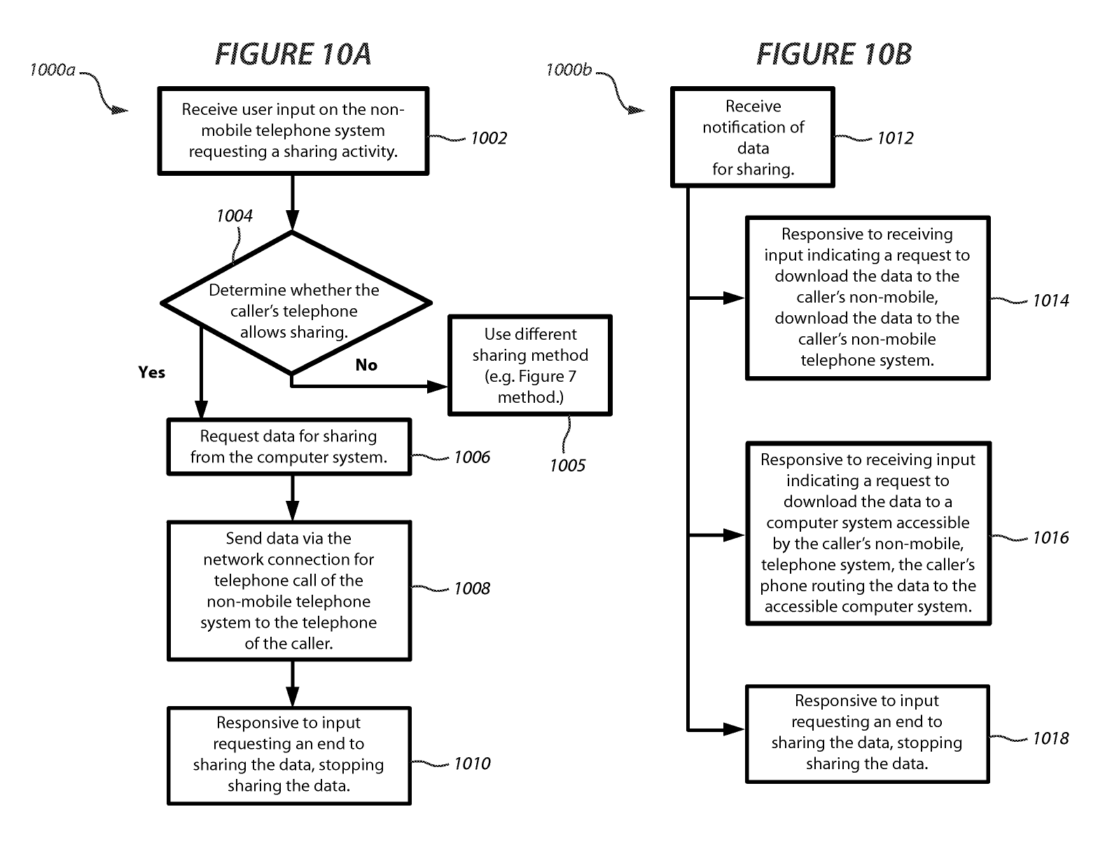

FIG. 10A is a flowchart of another embodiment 1000a of a method for a non-mobile telephone system to share data of a computer system from a user's perspective when the user is initiating the sharing. FIG. 10B is a flowchart of the method embodiment 1000b from the perspective of a caller receiving the shared data.

When a caller is calling on a POTs land line, the method embodiment 800 of FIG. 8 can likely always be used as long as the caller has Internet access. The Internet access does not need to be tied to the telephone. However, when using telephones which can process data in Internet protocols like TCP and IP, another method embodiment can be used without the need for resource access information and sending a resource location.

As mentioned earlier, the configuration data 345 can include identification information for the non-mobile telephone system 100 including its features. This data can be requested by the telephone software 320 of the caller's phone in a message whenever a call is made using VoIP or other computer network protocol. The caller's phone can simply ignore the message or respond with its features information. An example of features information is that it has access to a display capable of screen sharing. This could be part of a protocol so that phones of different manufacturers can perform functions with each other or the telephones can simply be of the same make or even the same model. The telephone software 320 can update this information in the call information in the telephony datastores 322. In other embodiments, specific services software 328 can send the features identification message and process any response.

When the user initiates a sharing request, the sharing services software 328 determines 1004 whether the caller's telephone allows sharing. The sharing services software 328 can base its determination on whether it can communicate with software on the caller's telephone which will allow the sharing. For example, if the caller's telephone is the same model and includes a copy of the sharing services software 328, the telephones can communicate and allow the sharing. Additionally, the sharing services software 328 may be able to communicate with other sharing programs. For instance, in the case of screen sharing, the software 328 may find a commercially available screen sharing services software program at the caller's end with which it can communicate.

Responsive to the information indicating sharing is not allowed or not being able to make such a determination, e.g. no response in a time period to the message, the sharing services software 328 can use a different method of sharing, like that in FIG. 8. Responsive to determining that the caller's telephone allows sharing, the sharing services software 328 on the user's non-mobile telephone system 100 requests 1006 data for sharing from a computer system such as a paired computer system, and sends 1008 the data via a network connection which supports an Internet computer protocol and over which the non-mobile telephone system is connected in a telephone call with the caller.

Responsive to the input requesting an end to sharing of the data, the sharing services software ends 1010 the sharing of the data. For example, the user can select a “Stop Sharing” display button. Another form of input which can stop sharing of the data is ending the call, for example, by hanging up the handset or pressing an end call button or the caller hanging up as mentioned above.

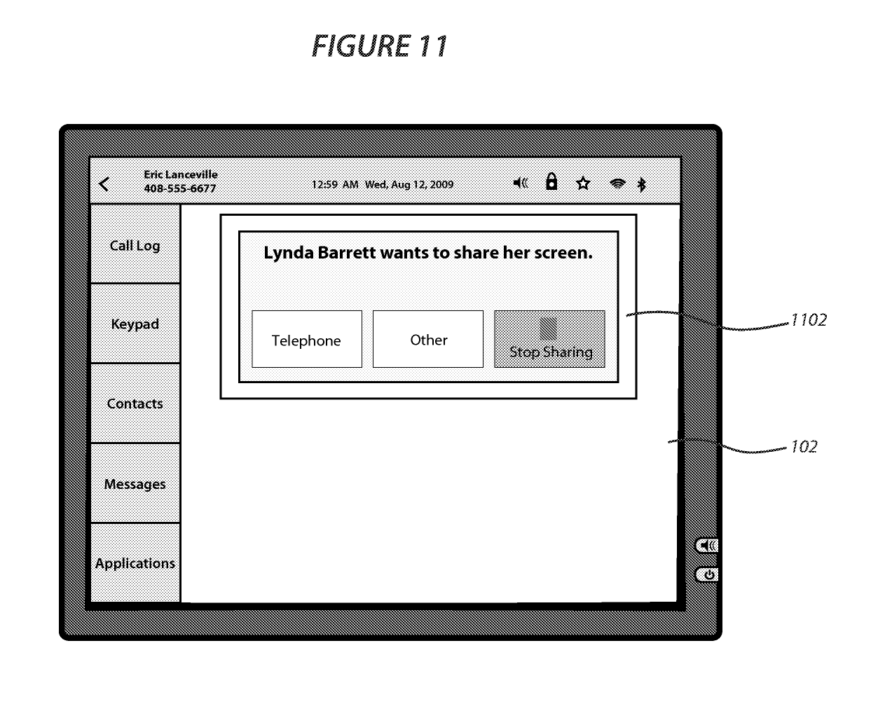

As shown in the example embodiment of FIG. 10B illustrating sharing from the recipient's perspective, the caller receives 1012 notification of data for sharing. In the embodiment shown in FIG. 11, it is assumed the caller has a non-mobile telephone system like that of system 100 for the user, and that the user's screen is the shared data. Displayed by the sharing services software 328 is a notification 1102 that the user wishes to share her screen. The caller can select a display button like “Stop Sharing” as input to prevent or stop receiving the data for sharing. In this example for screen sharing, the caller can select “Telephone” or “Other”. The “Other” can be a paired computer system, and a menu can be displayed to the caller if his telephone system 100c is paired to more than one.

Responsive to receiving input from the caller indicating a request to download the shared data, e.g. the user's telephone screen, to the caller's non-mobile telephone system 100c, sharing services software 328 on the caller's telephone 100c causes download 1014 of the data to the telephone system 100c, for example in screen sharing, causes display of the user's screen on the caller's telephone touchscreen 102c. Responsive to receiving input from the caller indicating a request to download to an accessible computer system, sharing services software 328 on the caller's telephone routes 1016 the data to an accessible computer system. For example, in the screen sharing case, the software 328c causes display of the user's screen on a computer screen accessible to the caller's telephone 100c. In one embodiment, this computer screen is that of a computer system paired with the caller's telephone system 100c.

Responsive to the input requesting an end to sharing of the data, the sharing services software 328 on the caller's phone ends 1018 the sharing of the data. For example, the user can select a “Stop Sharing” display button. Another form of input which can stop sharing of the data is ending the call, for example, by hanging up the handset or pressing an end call button or the caller hanging up as mentioned above.

In the method embodiment examples of FIGS. 10A and 10B, the user and the caller can share data such as files and screens without having to exchange IP addresses other than those of the telephones, if not desired. The sharing services software 328 on the caller's telephone 100c can receive the data and share it with a paired computer system without having to provide the IP address of the paired computer system to the user's telephone 100. The identity of the paired computer system of the caller is kept local. Additionally, in the case of screen sharing, the sharing of data can be tied to those on the voice telephone call and ends automatically when the voice telephone call ends. There is not a requirement for a separate termination procedure for ending the sharing between the computers.

The technology may be embodied in other specific forms without departing from the spirit or essential characteristics thereof. Likewise, the particular naming and division of modules, routines, applications, features, attributes, methodologies and other aspects are not mandatory, and the mechanisms that implement the technology or its features may have different names, divisions and/or formats. Furthermore, as will be apparent to one of ordinary skill in the relevant art, the modules, applications, routines, features, attributes, methodologies and other aspects of the embodiments disclosed can be implemented as software, hardware, firmware or any combination of the three. Of course, wherever a component, an example of which is an application, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of programming.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. In a non-mobile telephone system, a method for processing a service request call feature comprising:
responsive to user input selection of a display icon on a graphical user interface of the non-mobile telephone system indicating selection of a service, retrieving stored account data for that service;
transferring the account and logistics data to a system of the service in a request message; and
displaying a response from the service to the request message.

2. The method of claim 1 wherein transferring the account and logistics data to a system of the service further comprising
transferring the account and logistics data in a telephone call from the non-mobile telephone system to a similar non-mobile telephone system of the service; and
further comprising receiving a response from the non-mobile telephone system of the service in the same telephone call.

3. The method of claim 1 further comprising responsive to the system of the service being capable of processing text based data, formatting the account and logistics data in a text based format for processing by a text based application of a recipient system of the service.

4. The method of claim 1 further comprising responsive to the system of the service being a telephone system, causing a voicemail message with the account and logistics data to be sent to the telephone system of the service.

5. In a non-mobile telephone system including a graphical user interface display, a method for processing a call back call feature comprising:
receiving user input from the graphical user interface display requesting an incoming call be identified for call back;
placing identification information for the incoming call in a call back queue;
sending a message to a telephone of the incoming call that a caller associated with the call will be called back;
terminating the incoming call; and
responsive to call back criteria, displaying a reminder with the identification information on the graphical user interface to call back the incoming call.

6. In a non-mobile telephone system including a graphical user interface display, a method for updating a call log feature comprising:
determining whether a message was associated with a call; and
responsive to determining that a message was associated with the call, displaying a message indicator next to the identification information for the call.

7. In a non-mobile telephone system including a graphical user interface display, a method for updating a messages display feature comprising:
querying message receiving modules of at least one other computer system communicatively coupled to the non-mobile telephone system for notification of a new message;
messages processed by the message receiving systems being in different message protocols; and
generating in a single display view, a display of messages of different message protocols with identifying information including the message protocol of each message.

8. The method of claim 7 further comprising wherein at least one other computer system includes a mobile device.

9. A method for a non-mobile telephone system controlling sharing of data of another computer system comprising:
receiving input on the non-mobile telephone system requesting sharing of data stored on the other computer system;
sharing the data stored on the computer system at a resource location;
providing notification of the resource location; and
responsive to input requesting an end to sharing of the data, stopping sharing of the data.

10. The method of claim 9 further comprising generating resource access information to access the resource location and providing notification of the password.

11. The method of claim 10 further comprising a recipient non-mobile telephone system displaying the resource access information and the resource location.

12. The method of claim 9 wherein sharing data stored on the computer comprises screen sharing of data displayed on a computer screen of the other computer system.

13. The method of claim 9 wherein sharing data stored on the other computer system at a resource location comprises downloading a file to the resource location.

14. The method of claim 9 wherein input requesting an end to sharing the data is ending the call.

15. The method of claim 9 wherein the non-mobile telephone system and the other computer system are in a pair.

16. The method of claim 14 further comprising the non-mobile telephone system and the other computer system pairing by each system sending a respective unique identification to the other system to form a pair, and each system verifying the respective unique identification of the other system.

17. The method of claim 15 wherein the non-mobile telephone system initiates the pairing with the other computer system responsive to input from a user interface of the non-mobile telephone system.

18. The method of claim 14 wherein the non-mobile telephone system shares data of only the other computer system with which it is paired.
